(19) United States
(12) Patent Application Publication
(10) Pub. No.: US 2023/0068465 A1
(43) Pub. Date: Mar. 2, 2023

(54) FULLY AUTOMATED CUSTOMER TARGETING ALGORITHM OPTIMIZED TO MAXIMIZE COMMERCIAL VALUE USING MACHINE LEARNING METHODS

(71) Applicant: COUPANG CORP., Seoul (KR)

(72) Inventors: Xinli Bao, Palo Alto, CA (US); Chen Peng, Sunnyvale, CA (US); Michael Rowan Savio, Seoul (KR); Seongmin Lee, Seoul (KR)

(73) Assignee: COUPANG CORP.

(21) Appl. No.: 17/446,217

(22) Filed: Aug. 27, 2021

(51) Int. Cl. G06Q 30/02; G06N 20/20

(52) U.S. Cl. CPC G06Q 30/0256; G06Q 30/0271; G06N 20/20

(57) ABSTRACT

A method for targeting advertising includes receiving, at a first server, customer action information associated with the customer, and receiving a plurality of advertising campaigns. The method also includes generating, using a first algorithm, a list of products derived from the customer action information that the customer may have interest in over a first time period, and generating, using a second algorithm, a ranked list of product categories derived from the customer action information that, if purchased by the customer, would generate a highest amount of revenue over a second time period. The method further includes sending a first communication associated with a first advertising campaign of the plurality of advertising campaigns to a customer device, the first advertising campaign chosen by a third algorithm that incorporates, as input, the list of products and the ranked list of product categories.

### TECHNICAL FIELD

The present disclosure generally relates to computerized systems and methods for targeted advertising to a customer. In particular, embodiments of the present disclosure relate to inventive and unconventional systems relate to the assignment of advertising campaigns based on multiple artificial intelligence and/or machine learning models.

### BACKGROUND

For E-commerce businesses involved with the selling of products to customers, targeted advertising is utilized to help direct customers to the products they want/need and maximize revenue by selling those products to the customers. To do this, E-commerce businesses will make use of customer data that is either gathered directly through commercial interactions or obtained from third party vendors that aggregate customer data. This customer data is then analyzed and advertisements or other various promotions can be sent to customers that are more relevant to customers than non-directed advertising.

In this type of customer centric marketing, one of the main issues is figuring out the best promotion to offer for each customer. Historically, marketers would implement business rules such as choosing a promotion that matches a customer recent purchasing habits, and then implement some ad-hoc strategy to prioritize a particular promotion over another (in cases where a customer may qualify for multiple potential promotions). This prioritization strategy would usually be built on a one-off piece of customer analysis combined with other commercial imperatives.

There are deficiencies with the above described targeted advertising techniques. For example, despite being more relevant than non-targeted advertising, conventional targeted advertising techniques are still result in a multitude of non-relevant advertisements being sent to customers. This can both frustrate (i) customers end up wasting time viewing information that does not pertain to them and (ii) E-commerce businesses that spend resources on advertising that has a low return on investment. Additionally, ad-hoc prioritization strategies become even less effective when scaled up to apply to thousands or millions of customers. Further, when a non-relevant advertisement is sent to a customer, network resources are unnecessarily taxed in the form of excess bandwidth usage and inefficient use of processing resources.

Therefore, there is a need for improved methods and systems for (i) targeted advertising that is more effective at matching customers with advertisements/promotions for products they are interested in, and (ii) maximizing E-commerce business revenue from limited marketing budgets that is effective even when dealing with very large customers customer bases.

### SUMMARY

One aspect of the present disclosure is directed to a method for targeting advertising including receiving, at a first server, customer action information associated with the customer; receiving a plurality of advertising campaigns; generating, using a first algorithm, a list of products derived from the customer action information that the customer may have interest in over a first time period; generating, using a second algorithm, a ranked list of product categories derived from the customer action information that, if purchased by the customer, would generate a highest amount of revenue over a second time period; and sending a first communication associated with a first advertising campaign of the plurality of advertising campaigns to a customer device, the first advertising campaign chosen by a third algorithm that incorporates, as input, the list of products and the ranked list of product categories; wherein the first algorithm and the second algorithm are based on artificial intelligence and/or machine learning models, wherein the third algorithm is determined by predetermined business rules.

Another aspect of the present disclosure is directed to a system for targeted advertising to a customer including: a memory storing instructions; and at least one processor configured to execute the instructions to: receive customer action information associated with the customer; receive a plurality of advertising campaigns; generate, using a first algorithm, a list of products derived from the customer action information that the customer may have interest in over a first time period; generate, using a second algorithm, a ranked list of product categories derived from the customer action information that, if purchased by the customer, would generate a highest amount of revenue over a second time period; and send a first communication associated with a first advertising campaign of the plurality of advertising campaigns to a customer device, the first advertising campaign chosen by a third algorithm that incorporates, as input, the list of products and the ranked list of product categories; wherein the first algorithm and the second algorithm are based on artificial intelligence and/or machine learning models; wherein the second algorithm outputs a solution based on either random forest machine learning or deep machine learning depending on model accuracy measurements.

Yet another aspect of the present disclosure is directed to a system for targeted advertising to a customer including: memory storing instructions; and at least one processor configured to execute the instructions to: receive customer action information associated with the customer; receive a plurality of advertising campaigns; generate, using a first algorithm based on artificial intelligence and/or machine learning models, a list of products derived from the customer action information that the customer may have interest in over a first time period; generate, using a second algorithm, a ranked list of product categories derived from the customer action information that, if purchased by the customer, would generate a highest amount of revenue over a second time period, the second algorithm based on artificial intelligence and/or machine learning models; generate a ranked list of at least two advertising campaigns of the plurality of advertising campaigns chosen by the third algorithm that incorporates, as input, the list of products and the ranked list of product categories, the ranked list of at least two advertising campaigns including the first advertising campaign as being ranked first and a second advertising campaign as being ranked second; send a first communication associated with a first advertising campaign of the plurality of advertising campaigns to a customer device, the first advertising campaign chosen by a third algorithm that incorporates, as input, the list of products and the ranked list of product categories; and send a second communication associated with the second advertising campaign to the customer device at a time later than the sending of the first communication associated with the first advertising campaign; wherein the list of products is generated by the first algorithm from a first subset of the customer action information, the first subset being information that specifically corresponds to the customer; wherein the ranked list of product categories is generated by the second algorithm from a second subset of the customer action information, the second subset being information that specifically corresponds to the customer and a group of customers to which the customer belongs.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a network comprising computerized systems for communications enabling targeted promotional campaigns, consistent with the disclosed embodiments.

FIG. 4 is a schematic block diagram illustrating an exemplary embodiment of the promotional campaign system, consistent with the disclosed embodiments.

FIG. 5 is a flowchart illustrating an exemplary embodiment of a promotional campaign method, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for targeted advertising to a customer.

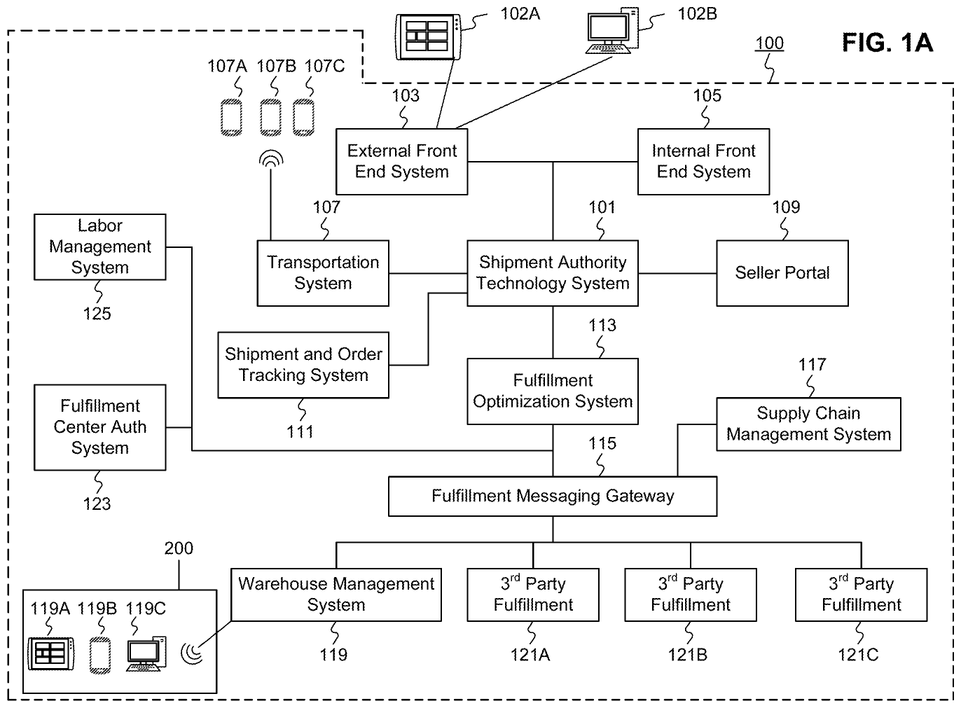

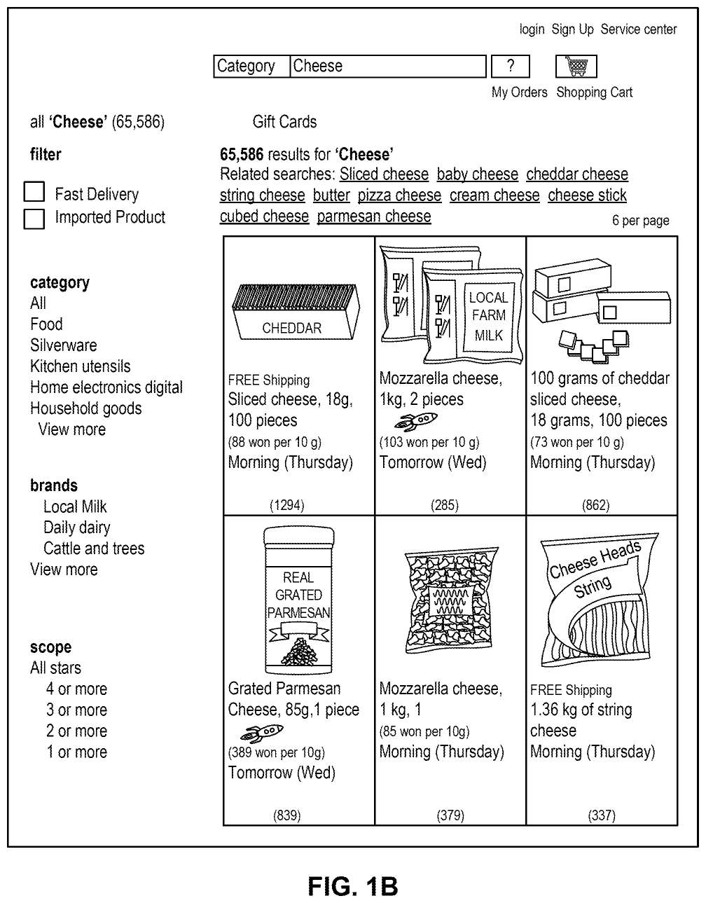

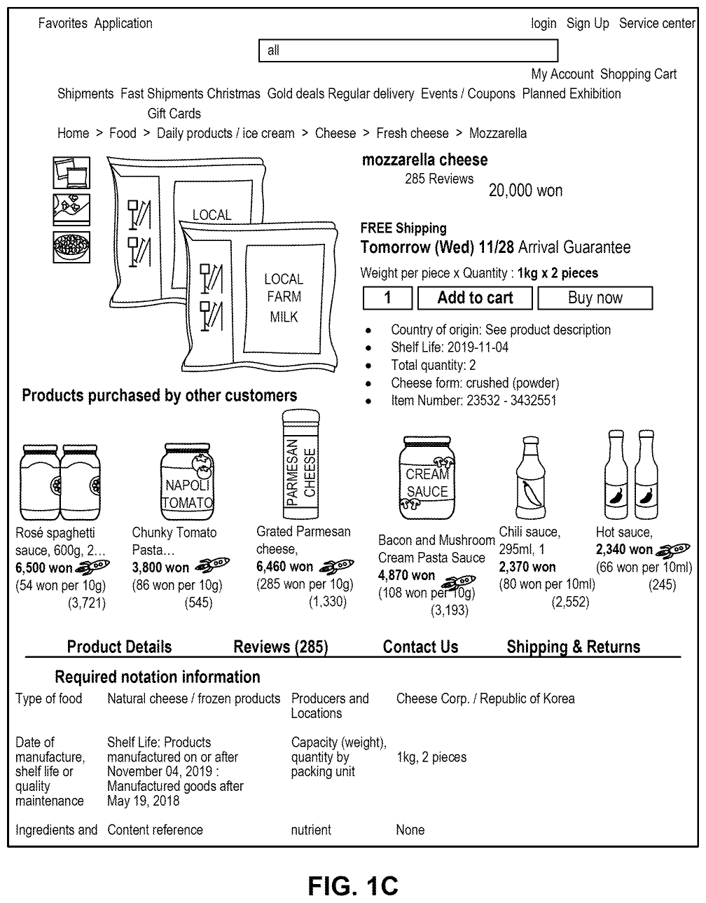

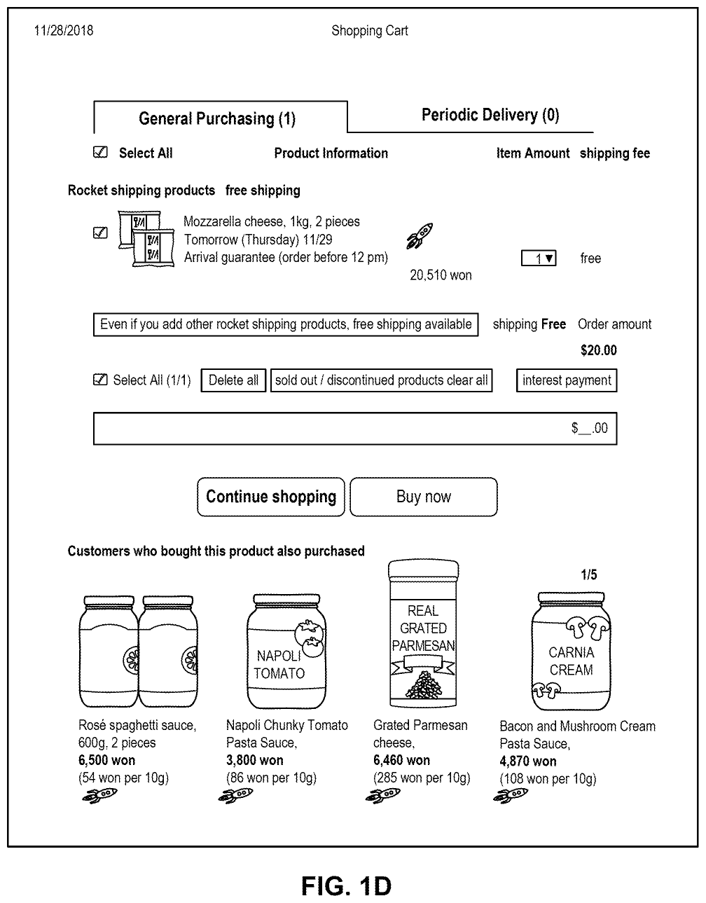

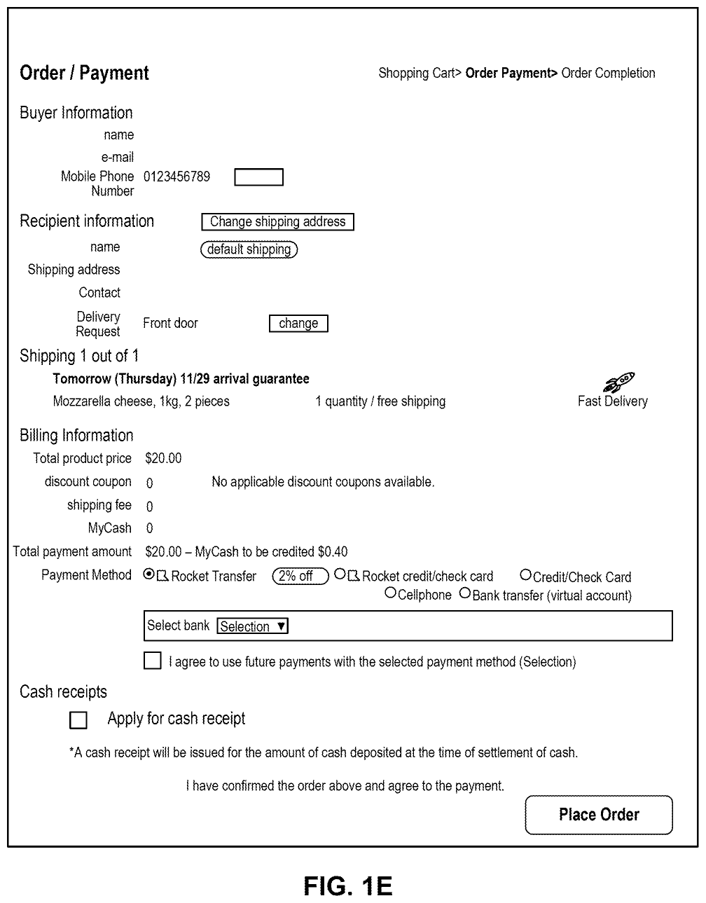

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

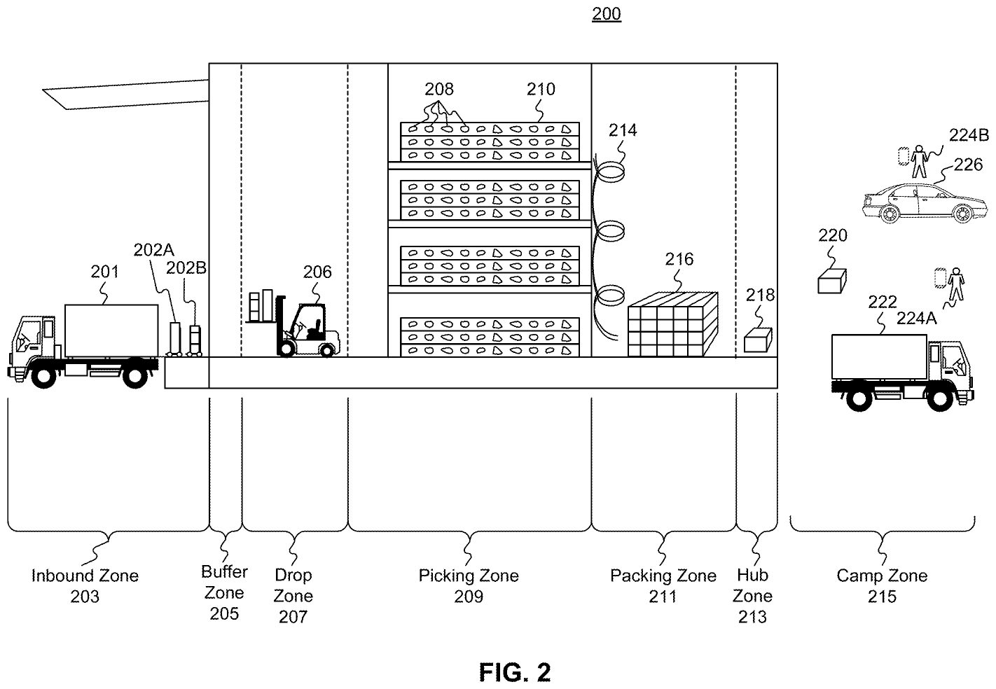

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 2246.

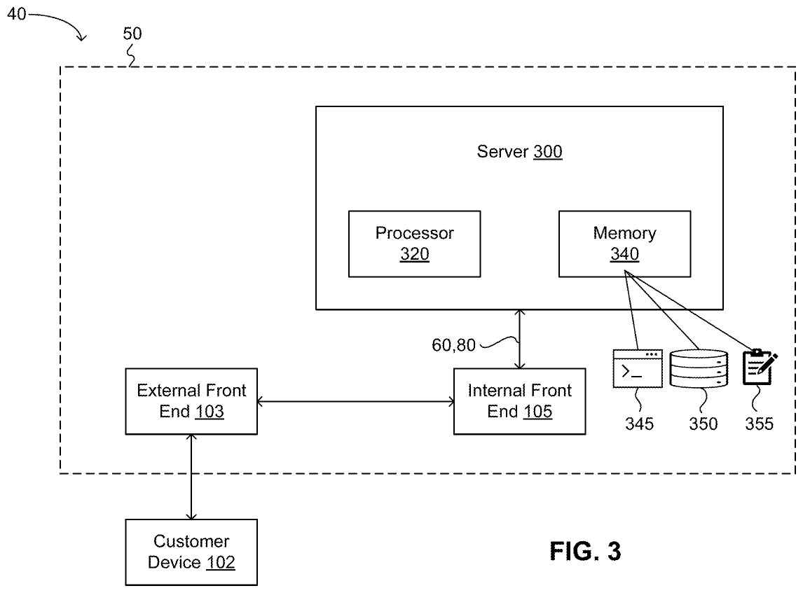

FIG. 3 is a schematic block diagram illustrating an exemplary embodiment of a network 40 comprising computerized systems for communications enabling targeted promotional campaigns, consistent with the disclosed embodiments. As seen in FIG. 3, the promotional campaign system 50 includes a server 300.

The basic components of server 300 include processor 320, and memory device 340, although server 300 may contain other components including those components that facilitate electronic communication. Other components may include user interface devices such as an input and output devices (not shown). Server 300 may include computer hardware components such as a combination of Central Processing Units (CPUs) or processors, buses, memory devices, storage units, data processors, input devices, output devices, network interface devices, and other types of components that are understood to those skilled in the art. Server 300 may further include application programs that may include software modules, sequences of instructions, routines, data structures, display interfaces, and other types of structures that execute operations of the present invention.

One of the hardware components in server 300 is processor 320. Processor 320 may be an ASIC (Application Specific Integrated Circuit) or it may be a general purpose processor. Processor 320 may include more than one processor. For example, processors may be situated in parallel, series, or both in order to process all or part of the computer instructions that are to be processed.

Memory device 340 may include all forms of computer-readable storage mediums such as non-volatile or volatile memories including, by way of example, semiconductor memory devices, such as EPROM, RAM, ROM, DRAM, EEPROM, and flash memory devices; magnetic disks such as internal hard disks and removable disks; magneto-optical disks; DVD disks, and CD-ROM disks. Memory device 340 may be used to store program code 345, a data lake 350, and business rules 355.

Server 300 is configured to receive information from the internal front end system 105 including customer action information 60 and a plurality of advertising campaigns 80. Customer action information 60 may include: customer purchase behavior (e.g., products purchased, frequency of purchases, repeat purchases, etc.), customer browsing history, customer searching history, loyalty program membership, loyalty program activity, and loyalty program benefit eligibility. A variety of business constraints 358 (e.g., which vendors are offering promotions, what kind of and how many discounts can be offered for a particular product or product category while maintaining profitability, etc.) determine what the plurality of advertising campaigns are at any given time.

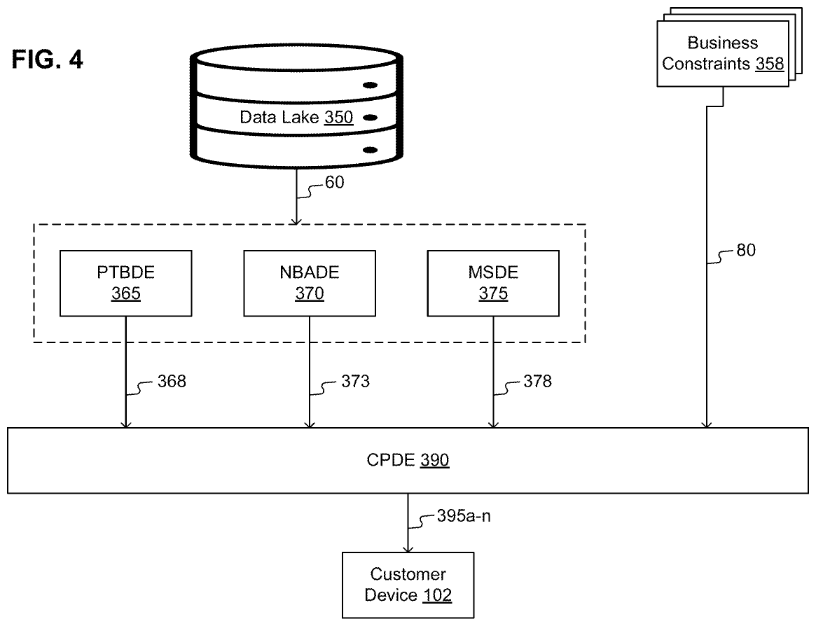

FIG. 4 is a schematic block diagram illustrating an exemplary embodiment of the promotional campaign system 50, consistent with the disclosed embodiments.

As seen in FIG. 4, the data lake 350 contains a collection of customer action information 60. In some embodiments, the internal front end system 105 updates this information periodically, in real-time, or on demand, for example, by retrieving relevant data from data lake 350. Periodically, certain sets of the customer action information 60 are directed by the processor 320 to be evaluated under several machine learning (ML)/artificial intelligence (AI) derived algorithms implemented by various decision engines 365, 370, 375. The ML/AI methods include deep learning and random forest. It is noted that decision engines 365, 370, 375 are exemplary and that less or more than these may be used by the processor 320.

The propensity to buy decision engine (PTBDE) 365 implements one of these ML/AI derived algorithms. The PTBDE 365 utilizes some of the customer action information 60 to identify customer interest in different sets of products over a set period of time. In some embodiments, the PTBDE 365 is configured to determine which customers have a high propensity to buy a particular target category/brand/device, and therefore drive a higher incremental purchase rate. For example, multiple categories/brands/device models can be used in the PTBDE 365; PTBDE 365 may be configured to receive updated models on a regular or sporadic basis. The output of the PTBDE 365 may be in the form of a list of desired products 368. For example, the PTBDE 365 uses information specific to a particular customer (e.g., the customer's previous purchases, products that the customer search for on the external front end system 103, and other browsing history on the system 103) to predict a list of products that customer would be interested in purchasing over the next seven days. The list 368 may or may not be ranked in order of estimated customer interest. The prediction by the PTBDE 365 can be made, for example, via deep learning and/or random forest machine learning methods that use multiple layers to progressively extract higher-level features from the raw input so that predictions made by the PTBDE 365 will be more accurate over time.

For example, the random forest algorithm may be implemented for each category/brand/device model with more than two hundred features to predict any particular customer's likelihood to make a purchase in the target category in the next seven days. In some embodiments, these features can include luxury item purchase behavior, category specific behavior, premium membership usage, browsing behavior, or the like. In some embodiments, the features in use may be different for each of the different categories/brands/devices. The models use most recent historical data to train and optimize overall accuracy rate and true positive rate based on several model parameters (tunning, e.g., number of trees and tree depth). In addition, initial validations may be provided to evaluate each model's performance including the purchase rate by model score decile and category coverage rate. Specifically, the validation proves that the model can identify the high propensity customer with higher purchase rate. Table 1 below is an example of the validation. Top three decile (based on model score) can identify 89% of diaper customers (see starred value). As seen below, the purchase rate decreases as the decile number gets bigger (the bigger the decile number is, the less likely that the customer will buy a product in the category).

TABLE 1
Diaper Purchase Rate by Propensity Decile (Collapsed View)

| Diaper | | | Diaper | Diaper | Accumulative | Diaper |
|---|---|---|---|---|---|---|
| Propensity | Diaper | Cohort | Purchase | Purchase | Diaper | Customers |
| Score | Propensity | Size | Customers | Rate | Customers | Coverage |
| P > 0 | 1 | 30,000 | 1,360 | 4.53% | 1,360 | 70% |
| | 2 | 30,000 | 221 | 0.74% | 1,581 | 82% |
| | 3 | 30,000 | 141 | 0.47% | 1,722 | 89%* |
| | 4 | 30,000 | 77 | 0.26% | 1,799 | 93% |
| | 5 | 30,000 | 61 | 0.20% | 1,860 | 96% |
| P = 0 | P = 0 | 150,000 | 73 | 0.05% | 1,933 | 100% |

The next best action decision engine (NBADE) 370 implements another of these ML/AI derived algorithms. The NBADE 370 utilizes a different set of the customer action information 60 (different than what the PTBDE 365 utilizes) to identify what types of potential purchases by a customer over a set period of time would most likely maximize a customer's lifetime expenditures on the system 103. Thus, the output of NBADE 370 may be in the form of a ranked list of product categories 373 that, if purchased by the customer, is estimated produce the most repeat purchases or most revenue. For example, the NBADE 370 uses information aggregated from many customers (e.g., product categories with high tendency for repeat purchases, product categories with high profit margins, etc.) in combination with information specific to a particular customer (e.g., customer's previous purchases) to predict the customer's likely next ninety days revenue. This prediction by the NBADE 370 can be made, for example by using several models including deep learning and random forest machine learning methods to simulate a multitude (e.g., hundreds) of alternative customer actions that the customer may take in the next four weeks. Utilizing model accuracy measurements (e.g., mean absolute errors), the customer action that has the highest predicted ninety days revenue is the top recommended action for the customer.

A marketing susceptibility decision engine (MSDE) 375 may, in some embodiments, implement the same or different ML/AI derived algorithms to analyze the customer action information 60. The MSDE 375 utilizes a different set of the customer action information 60 (different than what the PTBDE 365 or NBADE 370 utilizes) to identify how likely a customer is to change their purchasing behavior based on viewing advertisements/promotions. Thus the output of the MSDE 375 may be in the form of a marketing susceptibility list 378. For example, the MSDE 375 uses information specific to a particular customer (e.g., the customer's history of new purchases following a promotion, history of products that the customer searched for on the external front end system 103 following a promotion, time spent viewing promotions on the external front end system 103) to predict whether a customer will be likely to respond to advertisements/promotions in general or for specific products/product categories by making a purchase. For example, the marketing susceptibility list 378 may indicate an estimated likelihood of change in purchasing behavior for product categories based on receiving marketing for each of the product categories. This prediction by the MSDE 375 can be made, for example, via deep learning machine learning methods.

While the above-described three different decision engines 365, 370, 375 and their associated ML/AI derived algorithms are described above, this list is not exhaustive and the processor 320 may make use of other types of decision engines or other ML/AI derived algorithms. Outputs 368, 373, 378 of the above-described decision engines 365, 370, 375 along with the plurality of advertising campaigns 80 are fed into the customer promotion decision engine (CPDE) 390. The processor 320 running the CPDE 390 uses various business rules 355 to generate a ranked list of advertising campaigns 395a-n selected from the plurality of advertising campaigns 80 to be offered to the customer at device 102. The ranked list of advertising campaigns 395a-n may be in any suitable form (plain text file, spreadsheet, etc.) that indicates that certain advertising campaigns 395 are prioritized for a customer over others. For example, a propensity table generated by the PTBDE 365 may include columns for member identification, product category, and a propensity score. Additionally, an NBA table generated by the NBADE 370 may include columns for member identification, and NBA impact. Business rules 335 may merge the propensity table with the NBA table and then label and rank each member identification on propensity and NBA output by product (example group labels may include core group, nominal group, and no signal). In some arrangements the list 359 may include as few as one advertising campaign 395a. In arrangements where there are multiple advertising campaigns 395a-n are chosen by the CPDE 390, not all of the campaigns 395a-n may be presented to the customer at the customer device 102. For example, if the CPDF 390 chooses a diaper promotion as the top ranked advertising campaign 395a, a running shoe promotion as the second ranked advertising campaign 395b, and a jewelry promotion as the third ranked advertising campaign 395c, then only the top ranked (i.e. most likely to maximize lifetime revenue from the customer) campaign 395a may be initially presented to the customer at the device 102 when logged onto the system 103. If the customer logs onto the system 103 a second time within a predetermined time period (e.g., a week), the second ranked campaign 395b may be presented to the customer on the device 102. However, if the customer does not log onto the system 103 a third time before the end of the predetermined time period, the third ranked campaign 395c may not be presented to the customer.

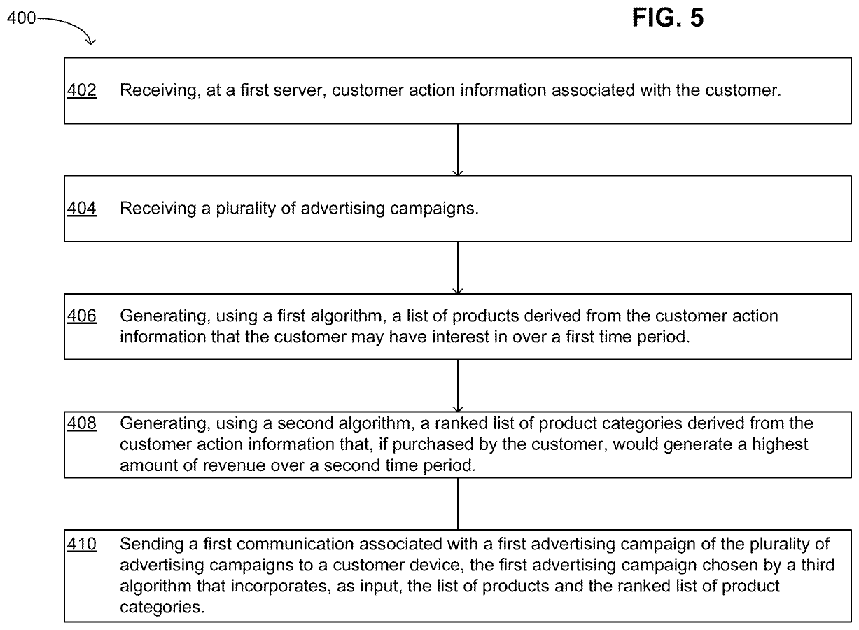

FIG. 5 is a flowchart illustrating an exemplary embodiment of a promotional campaign method 400, consistent with the disclosed embodiments. The method begins with step 402.

Step 402 is receiving, at a first server 300, customer action information 60 associated with the customer. For example, the server 300 may receive from the system 105, customer purchase behavior (e.g., products purchased, frequency of purchases, repeat purchases, etc.), customer browsing history, customer searching history, loyalty program membership, loyalty program activity, and loyalty program benefit eligibility.

Step 404 is receiving a plurality of advertising campaigns 80. Each of the advertising campaigns may be a promotion (e.g., discount price, buy one get one free, rewards points) or an advertisement. There may be hundreds of current advertising campaigns 80 relating to specific products or product categories that are available for distribution to customers.

Step 406 is generating, using a first algorithm 365, a list of products 368 derived from the customer action information 60 that the customer may have interest in over a first time period. For example, the PTBDE 365 may determine based on a subset of the information 60 that a customer is interested in purchasing dog food, video games, diapers, and a refrigerator in the next week.

Step 408 is generating, using a second algorithm 170, a ranked list of product categories 173 derived from the customer action information that 80, if purchased by the customer, would generate a highest amount of revenue over a second time period. For example, the NBADE 370 may determine based on a different subset of the information 60 that the purchases in the following categories will generate the most revenue over the lifetime of the customer in descending order: pet food, cleaning supplies, and baby products.

Step 410 is sending a first communication associated with a first advertising campaign 195a of the plurality of advertising campaigns 80 to a customer device 102, the first advertising campaign 195a chosen by a third algorithm 390 that incorporates, as input, the list of products 168 and the ranked list of product categories 173. For example, based on business rules 355, the CPDE 390 may determine that the best promotion to offer the customer is a promotion for dog food since pet food is the determined highest revenue generating product category and the customer has shown a propensity to purchase dog food within the next week. Additionally, the CPDE 390 may determine that the second best promotion to offer the customer is a promotion for diapers since baby products are determined to be the third highest revenue generating product category and the customer has shown a propensity to purchase diapers within the next week. As a result of these determinations, the device 102 may (i) display the dog food promotion when the customer logs onto the system 103 for the first time in the week and (ii) display the diaper promotion when the customer logs onto the system 103 for a second time in the week.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented method for targeting advertising to a customer comprising:
receiving, at a first server, customer action information associated with the customer;
receiving a plurality of advertising campaigns;
generating, using a first algorithm, a list of products derived from the customer action information that the customer may have interest in over a first time period;
generating, using a second algorithm, a ranked list of product categories derived from the customer action information that, if purchased by the customer, would generate a highest amount of revenue over a second time period; and
sending a first communication associated with a first advertising campaign of the plurality of advertising campaigns to a customer device, the first advertising campaign chosen by a third algorithm that incorporates as input, the list of products and the ranked list of product categories;
generating a ranked list of at least two advertising campaigns of the plurality of advertising campaigns chosen by the third algorithm that incorporates, as input, the list of products and the ranked list of product categories;
wherein the first algorithm and the second algorithm are based on artificial intelligence or machine learning models,
wherein the third algorithm is determined by predetermined business rules.

2. The computer-implemented method of claim 1:
wherein the first algorithm is based on random forest machine learning;
wherein the second algorithm is based on random forest machine learning and deep machine learning;
wherein the second algorithm outputs a solution based on either random forest machine learning or deep machine learning depending on model accuracy measurements.

3. The computer-implemented method of claim 1, wherein the customer action information includes at least one customer purchase behavior, customer browsing history, customer searching history, loyalty program membership, loyalty program activity, and loyalty program benefit eligibility.

4. The computer-implemented method of claim 1, wherein the list of products is generated by the first algorithm from a first subset of the customer action information, the first subset being information that specifically corresponds to the customer.

5. The computer-implemented method of claim 1, wherein the ranked list of product categories is generated by the second algorithm from a second subset of the customer action information, the second subset being information that specifically corresponds to the customer and a group of customers to which the customer belongs.

6. The computer-implemented method of claim 1:
wherein the method further comprises the ranked list of at least two advertising campaigns including the first advertising campaign as being ranked first and a second advertising campaign as being ranked second; and
wherein the method further comprises sending a second communication associated with the second advertising campaign to the customer device at a time later than the sending of the first communication associated with the first advertising campaign.

7. The computer-implemented method of claim 1:
wherein the method further comprises generating, using a fourth algorithm, a marketing susceptibility list derived from the customer action information, the marketing susceptibility list indicating an estimated likelihood of change in purchasing behavior for product categories based on receiving marketing for each of the product categories,
wherein the third algorithm additionally incorporates, as input, the marketing susceptibility list.

8. The computer-implemented method of claim 7, wherein the fourth algorithm is based on artificial intelligence and/or machine learning models.

9. The computer-implemented method of claim 7:
wherein the method further comprises generating a ranked list of at least two advertising campaigns of the plurality of advertising campaigns chose by the third algorithm that incorporates, as input, the list of products and the ranked list of product categories, the ranked list of at least two advertising campaigns including the first advertising campaign as being ranked first and a second advertising campaign as being ranked second; and
wherein the method further comprises sending a second communication associated with the second advertising campaign to the customer device at a time later than the sending of the first communication associated with the first advertising campaign.

10. A computer-implemented system for targeted advertising to a customer comprising:
a memory storing instructions; and
at least one processor configured to execute the instructions to:
receive, at a first server, customer action information associated with the customer;
receive a plurality of advertising campaigns;
generate, using a first algorithm, a list of products derived from the customer action information that the customer may have interest in over a first time period;
generate, using a second algorithm, a ranked list of product categories derived from the customer action information that, if purchased by the customer, would generate a highest amount of revenue over a second time period; and
send a first communication associated with a first advertising campaign of the plurality of advertising campaigns to a customer device, the first advertising campaign chosen by a third algorithm that incorporates, as input, the list of products and the ranked list of product categories;
generate a ranked list of at least two advertising campaigns of the plurality of advertising campaigns chosen by the third algorithm that incorporates, as input, the list of products and the ranked list of product categories;
wherein the first algorithm and the second algorithm are based on artificial intelligence or machine learning models;
wherein the second algorithm outputs a solution based on either random forest machine learning or deep machine learning depending on model accuracy measurements.

11. The computer-implemented system of claim 10:
wherein the first algorithm is based on random forest machine learning;
wherein the second algorithm is based on random forest machine learning and deep machine learning;
wherein the second algorithm outputs a solution based on either random forest machine learning or deep machine learning depending on model accuracy measurements.

12. The computer-implemented system of claim 10, wherein the customer action information includes at least one of customer purchase behavior, customer browsing history, customer searching history, loyalty program membership, loyalty program activity, and loyalty program benefit eligibility.

13. The computer-implemented system of claim 10, wherein the list of products is generated by the first algorithm from a first subset of the customer action information, the first subset being information that specifically corresponds to the customer.

14. The computer-implemented system of claim 10, wherein the ranked list of product categories is generated by the second algorithm from a subset of the customer action information, the second subset being information that specifically corresponds to the customer and a group of customers to which the customer belongs.

15. The computer-implemented system of claim 10:
wherein the ranked list of at least two advertising campaigns including the first advertising campaign as being ranked first and a second advertising campaign as being ranked second; and
wherein the processor is further configured to send a communication associated with the second advertising campaign to the customer device at a time later than the sending of the first communication associated with the first advertising campaign.

16. The computer-implemented system of claim 10:
wherein the processor is further configured to generate, using a fourth algorithm, a marketing susceptibility list derived from the customer action information, the marketing susceptibility list indicating an estimated likelihood of change in purchasing behavior for product categories based on receiving marketing for each of the product categories,
wherein the third algorithm additionally incorporates, as input, the marketing susceptibility list.

17. The computer-implemented system of claim 16, wherein the fourth algorithm is based on artificial intelligence and/or machine learning models.

18. The computer-implemented system of claim 16:
wherein the processor is further configured to generate a ranked list of at least two advertising campaigns of the plurality of advertising campaigns chosen by the third algorithm that incorporates, as input, the list of products and the ranked list of product categories, the ranked list of at least two advertising campaigns including the first advertising campaign as being ranked first and a second advertising campaign as being ranked second; and
wherein the processor is further configured to send a second communication associated with the second advertising campaign to the customer device at a time later than the sending of the first communication associated with the first advertising campaign.

19. The computer-implemented system of claim 10, wherein the first advertising campaign is an advertising campaign for a specific customer product.

20. A computer-implemented system for targeted advertising to a customer comprising:
a memory storing instructions; and
at least one processor configured to execute the instructions to:
receive, at a first server, customer action information associated with the customer;
receive, a plurality of advertising campaigns;
generate, using a first algorithm based on artificial intelligence and/or machine learning models, a list of products derived from the customer action information that the customer may have interest in over a first time period;
generate, using a second algorithm, a ranked list of product categories derived from the customer action information that, if purchased by the customer, would generate a highest amount of revenue over a second time period, the second algorithm based on artificial intelligence and/or machine learning models;
generate a ranked list of at least two advertising campaigns of the plurality of advertising campaigns chosen by a third algorithm that incorporates, as input, the list of products and the ranked list of product categories, the ranked list of at least two advertising campaigns including the first advertising campaign as being ranked first and a second advertising campaign as being ranked second;
send a first communication associated with a first advertising campaign of the plurality of advertising campaigns to a customer device, the first advertising campaign chosen by the third algorithm that incorporates, as input, the list of products and the ranked list of product categories; and
send a second communication associated with the second advertising campaign to the customer device at a time later than the sending of the first communication associated with the first advertising campaign;
wherein the list of products is generated by the first algorithm from a first subset of the customer action information, the first subset being information that specifically corresponds to the customer;
wherein the ranked list of product categories is generated by the second algorithm from a second subset of the customer action information, the second subset being information that specifically corresponds to the customer and a group of customers to which the customer belongs.
